(19) United States
(12) Patent Application Publication
(10) Pub. No.: US 2011/0303814 A1
(43) Pub. Date: Dec. 15, 2011

(54) Systems and Methods for Interchangeably Mounting Objects

(76) Inventor: Erich Schultz, San Rafael, CA (US)

(21) Appl. No.: 13/118,018

(22) Filed: May 27, 2011

Related U.S. Application Data
(60) Provisional application No. 61/348,827, filed on May 27, 2010.
(60) Provisional application No. 61/359,745, filed on Jun. 29, 2010.

(51) Int. Cl. F16B 2/20; F16M 13/00

(52) U.S. Cl. 248/316.7; 248/309.1; 248/200

(57) ABSTRACT

An interchangeable object mounting system is disclosed. The object mounting system comprises an object receptacle and an object. The object receptacle may be a front-, top-, or side-loading frame. The object has a flange portion adapted to fit into and be secured by the object receptacle, and a forward portion that, when the object is installed, is exposed by a central opening in the object receptacle and typically extends forwardly of the object receptacle. The object may be, for example, a working surface, such as a cork board or dry erase white board, a container, or an amusement device.

### CROSS-REFERENCE TO RELATED APPLICATIONS

This application claims priority to U.S. Provisional Patent Application No. 61/348,827, filed May 27, 2010, and to U.S. Provisional Patent Application No. 61/359,745, filed Jun. 29, 2010. The entire contents of both applications are incorporated by reference herein.

### BACKGROUND OF THE INVENTION

1. Field of the Invention

In general, the invention relates to receptacles, systems, and methods for mounting objects interchangeably, particularly on fixed surfaces, such as walls.

2. Description of Related Art

Mounting an object, such as a picture frame, to a wall often requires a fair amount of effort. In a typical situation, the person mounting the object will measure the object, measure the wall on which the object is to be placed to determine where the mounting hardware will go, place the mounting hardware, and then mount or hang the object on the hardware. Most of the time, if the object must be moved, or if a new object is to be hung in the place of the original, the original object is taken down and the entire process is repeated with the new object.

Certain developments have made mounting individual objects easier. For example, pressure sensitive stretch-release adhesive strips can be used to secure mounting hooks on walls for mounting relatively light objects, and the strips can be relatively easily removed from the wall surface in order to mount new objects. In some cases, adhesive strips or pads may be directly attached to the objects themselves. Additionally, template systems, such as that disclosed in U.S. Pat. No. 6,880,259, the contents of which are incorporated by reference in their entirety, can simplify the process of placing mounting hardware on a wall and make it easier to arrange objects like picture frames in a predefined grouping.

Front-loading picture frames that allow easy access to and removal of the pictures mounted within are also known in the art. U.S. Pat. No. 5,701,697, the contents of which are incorporated by reference in their entirety, discloses one type of front-loading picture frame. Generally speaking, front-loading picture frames have four spring-biased, beveled edges that open and close to provide access to the material that the frame is framing. These frames also typically have a very specific thickness of material that they can accommodate—if the material is too thick or too thin, the edges of the frame may not close or mesh properly.

Generally speaking, the capacity and type of material that any conventional frame can accept are defined and limited. Mounting larger objects on a wall often requires a mounting solution that is specific to the object, which may involve the design of a custom enclosure, such as a shadowbox. In any case, objects mounted in a traditional frame are typically behind a glass or plastic covering to protect them from dust, human hands, light, and other elements—users can view the object, but not interact with it.

The prior art does not provide a way to quickly and interchangeably mount a wide variety of objects on a wall or other fixed surface.

### SUMMARY OF THE INVENTION

One aspect of the invention relates to an object. The object comprises a forward portion connected to a flange portion. The forward portion extends forwardly of the flange portion, while the flange portion extends horizontally and vertically outward from at least one edge of the forward portion and has a defined thickness. The object is sized and adapted to fit within a receptacle, such as a frame. The defined thickness of the flange portion is within a defined range of thicknesses of material that can be accommodated by the frame. In embodiments according to this aspect of the invention, the forward portion of the object may be any one of a wide variety of things, including, but not limited to, writing boards (e.g. chalk and dry-erase boards), posting boards (e.g., cork or magnetic boards), containers (e.g., dispenser boxes, file holding and sorting containers, display containers), shelves, and amusement devices.

Another aspect of the invention relates to an object mounting system including an object, as set forth above, and a molding. The molding has peripheral structure and a central opening. The flange portion of the object is adapted to fit within the molding such that the forward portion is exposed through the central opening of the molding. In some cases, the forward portion may extend forwardly beyond the molding, and it may exceed the dimensions of the molding in at least one of height or width and in depth. Depending on the object and the embodiment, the flange portion may be a continuous sheet attached to the back of the forward portion, it may be an integrally-formed lip, extension, or protrusion on the forward portion, or it may comprise several independent members that are attached to the forward portion along different edges. In some cases, more than one object may be mounted in a receptacle.

In yet another aspect of the invention, the interchangeable object mounting system comprises an object receptacle and an object. The object receptacle includes at least three elongate peripheral backing members connected to each other at ends thereof to form a U-shape. The receptacle also comprises a corresponding plurality of at least three peripheral clamping members, each hingedly connected to one of the peripheral backing members for hinged movement between open and closed positions. Resilient members bear between the peripheral backing members and the peripheral clamping members to bias the peripheral clamping members toward the closed position. The receptacle defines a central opening. The object comprises a flange portion sized and arranged to be inserted between the peripheral backing members and the peripheral clamping members. The object also comprises a forward portion connected to or integral with the flange portion. When the object is in position within the object receptacle, it is exposed by the central opening and may extend in or forwardly of a plane in which the peripheral clamping members extend.

Further aspects of the invention relate to methods of interchangeably mounting objects on fixed surfaces.

Other aspects, features, and advantages of the invention will be set forth in the description that follows.

### BRIEF DESCRIPTION OF THE DRAWING FIGURES

The invention will be described with respect to the following drawing figures, in which like numerals represent like figures throughout the figures, and in which:

FIG. 1 is a perspective view of an interchangeable object mounting system according to one embodiment of the invention;

FIG. 2 is a cross-sectional view of the system, taken along Line 2-2 of FIG. 1;

FIG. 3 is a detailed cross-sectional view of the system of FIG. 1;

FIG. 4 is an exploded perspective view of the system of FIG. 1, illustrating the mechanism of mounting the system on a wall, as well as the placement of interchangeable objects in a receptacle;

FIGS. 5-10 are perspective views of various objects that may be used in the system of FIG. 1;

FIG. 11 is an exploded perspective view of a system according to another embodiment of the invention;

FIG. 12 is an exploded perspective view of a system according to an embodiment of the invention illustrating multiple objects being placed in a single object receptacle;

FIG. 13 is an elevational view illustrating the rotation of an object receptacle installed on a wall and the relationship between the object receptacle and an object positioned within;

FIG. 14 is an exploded perspective view of a system according to another embodiment of the invention, illustrating the use of decorative or informational layers;

FIG. 15 is an exploded perspective view of yet another embodiment of the invention in which the object receptacle is rear-loading; and

FIGS. 16-20 are schematic sectional views illustrating the arrangement of objects in the type of object receptacle illustrated in FIG. 15, and also illustrating certain features of the objects themselves.

### DETAILED DESCRIPTION

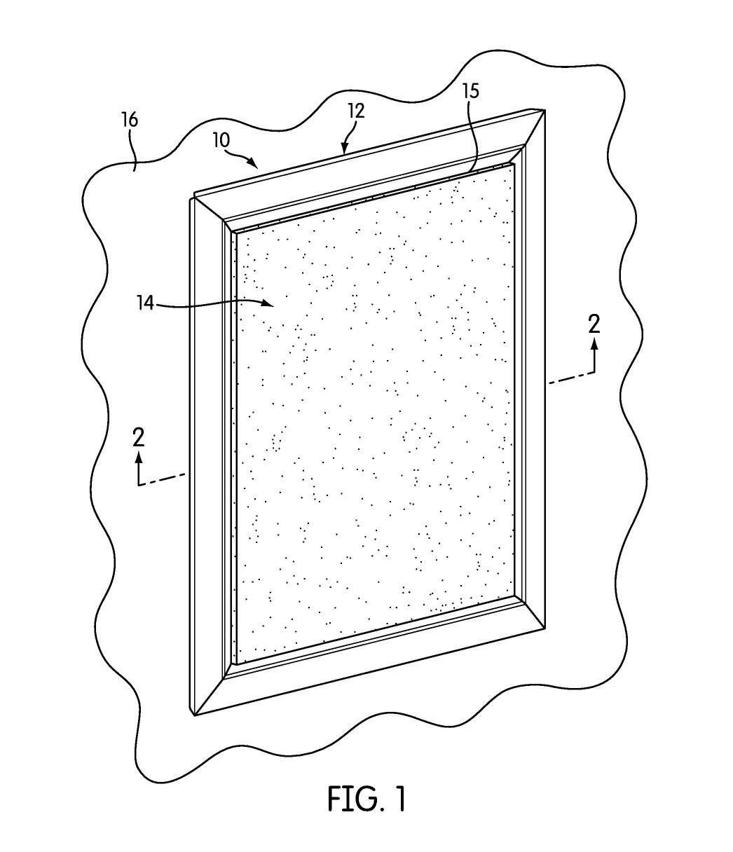

FIG. 1 is a perspective view of an interchangeable object mounting system, generally indicated at 10, according to one embodiment of the invention. The object mounting system 10 includes an object receptacle 12 and an object 14 mounted in the receptacle 12. The object receptacle 12 is adapted to interchangeably mount the object 14 to a surface 16. In the view of FIG. 1, the surface 16 is a generally vertical wall, although the object receptacle 12 may be used on horizontal and angled surfaces of other types as well, including ceilings, tables, and floors, and curved surfaces, such as poles. In some cases, object receptacles 12 may be attached back-to-back to one another (e.g., to form signage); therefore, the term “surface” should be construed to include cases in which the surface in question is the back of another object receptacle 12. Moreover, terms such as “horizontal” and “vertical” are used with respect to the coordinate system of the drawings; the absolute orientation or position of the elements in any particular use or installation may vary; these terms are not intended to be limiting.

In the embodiment of FIG. 1, the object receptacle 12 has the general shape and attributes of a frame—it provides a generally rectangular molding that extends around the perimeter of the object 14, and defines a central opening 15. However, unlike a traditional picture frame, a forward portion of the object 14 is exposed through the central opening 15 of the object receptacle 12, rather than being covered by a glass or plastic sheet. The object 14 may extend into the plane of the molding and forwardly of the object receptacle 12 itself. Although a four-sided rectangular frame is shown in FIG. 1, object receptacles 12 according to embodiments of the invention will generally have at least three connected sides, and may have more than four connected sides. The object 14 illustrated in FIG. 1 is a cork board; however, as will be described below in more detail, a wide variety of different types of objects may be used.

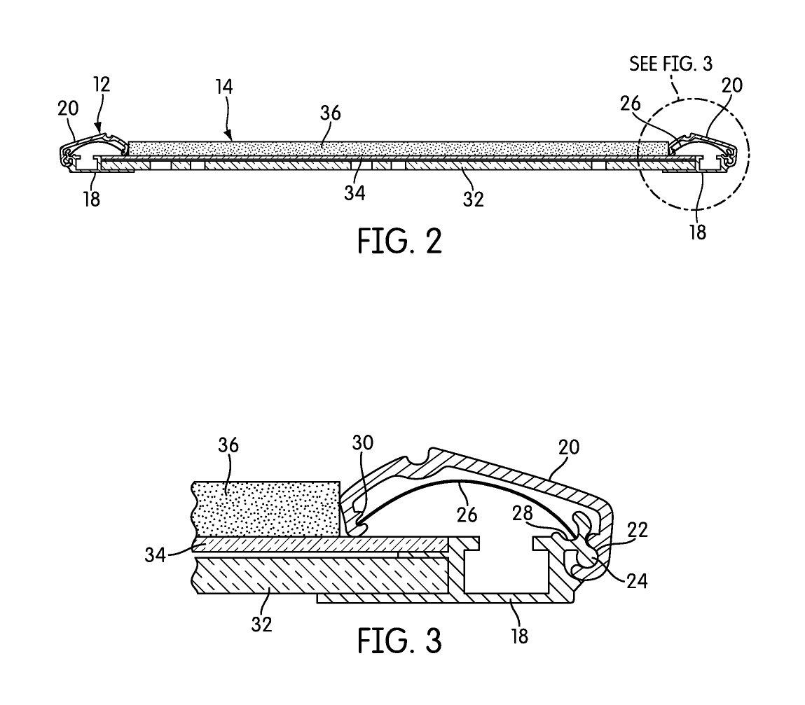

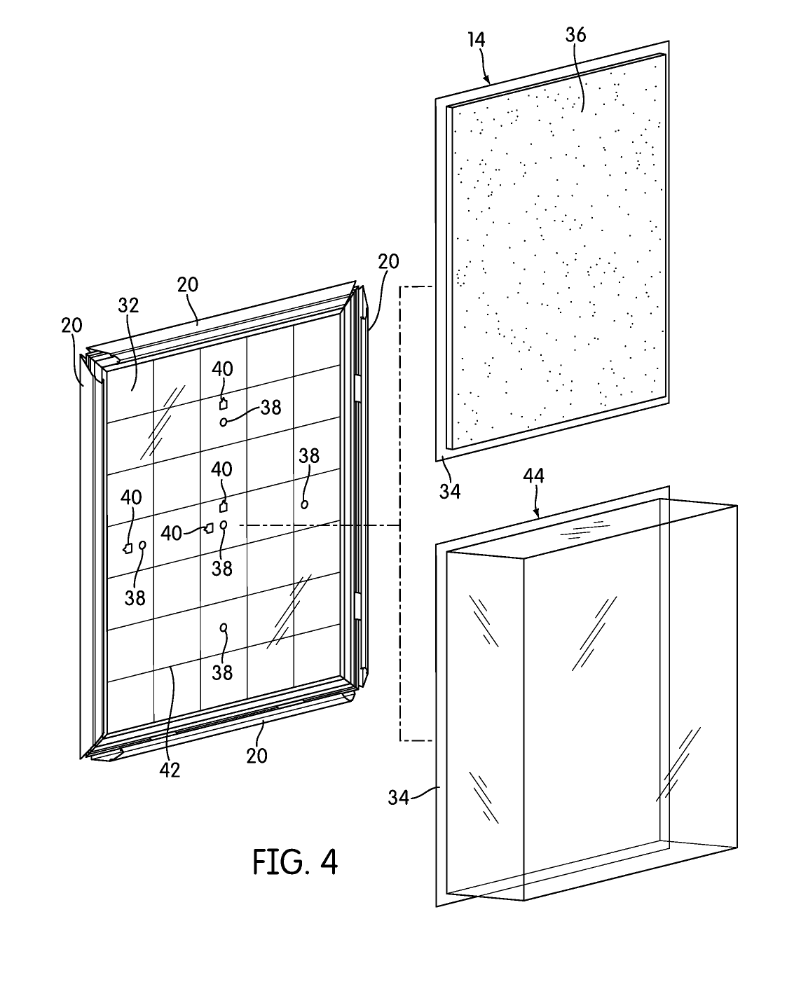

FIG. 2 is a cross-sectional view of the system 10 illustrated in FIG. 1, and FIG. 3 is a detail of one side of the view of FIG. 2. In the illustrated embodiment, the object receptacle 12 is a front-loading frame, although other types of receptacles may be used in other embodiments and will be described below in more detail. As shown in FIGS. 2 and 3, each side of the object receptacle 12 comprises a peripheral backing member 18 and a peripheral clamping member 20 that is mounted on the backing member 18 for rotation between open and closed positions. In this case, a U-shaped channel 22 on an inwardly-facing edge of the clamping member 20 engages a correspondingly sized and shaped outward projection 24 on the backing member 18 to connect the clamping member 20 and the backing member 18 and allow hinged movement. A resilient member 26, in this case a leaf spring, bears between a groove 28 in the backing member 18 proximate to the point of attachment of the clamping member 20 and a groove 30 in the clamping member 20 to bias the clamping member 20 toward and into the closed position shown in FIGS. 2 and 3. The clamping members 20 also serve as the outer face of the molding that surrounds the object 14, and for that reason may have additional external features, such as grooves, coloration, or a veneer, for decorative purposes.

The back of the object receptacle 20 in the illustrated embodiment comprises a backing sheet 32 that rests in a groove or stepped lip 34 provided by the backing members 18 and the clamping members 20. The backing sheet 32 may be held in place because of its placement in a groove, lip, or channel, or it may be held in place by the clamping members 20.

As will be described below in more detail, the use of a separable backing sheet 32 as the back of the object receptacle may have certain advantages in certain circumstances. However, the object receptacle 12 requires no backing at all, and in general, embodiments of the invention may use or omit a backing as desired. In some embodiments, clips, fasteners, adhesives, putties, and other forms of retaining structure may be used to retain the object 14 in the object receptacle 12 instead of a backing. In yet other embodiments, the wall 16 itself may serve as a backing and retaining structure.

FIGS. 2 and 3 also show the arrangement of the object 14 itself, which has two main parts: a flange portion 34, and a forward portion 36 of the object 14, which is mounted on, secured to, or otherwise integral with the flange portion 34. The forward portion 36 will often be a useful or useable thing, as will be described below, but it need not always be. In some cases, the forward portion 36 may have aesthetic or sculptural elements. Although the object 14 is depicted as being used with the object receptacle 12, as will be described below in more detail, the object 14 may be used with a wide variety of receptacles. Once the object 14 is placed in a receptacle, the association between the object 14 and receptacle and the engagement of the two may be temporary or permanent.

The flange portion 34 is larger than the forward portion 36 in at least one dimension, extends vertically and horizontally from at least one edge of the forward portion 36, and thus allows the object to be secured within the object receptacle 12. In the illustrated embodiment, the clamping members 20 clamp down on the flange portion 34 to secure the object 14 within the object receptacle 12, although other methods and modes of securing the object 14 will be described below in more detail.

The nature, dimensions, and extent of the flange portion 34, and the materials of which it is made, will vary greatly from object to object and embodiment to embodiment. If the forward portion 36 of the object 14 is, for example, a cork board, the flange portion 34 may be any material on which cork may be mounted. For example, the flange portion 34 may comprise a sheet of wood, metal, or plastic. Suitable plastics may include polyvinyl chloride (PVC), polymethyl methacrylate (PMMA), high density polyethylene (HDPE), polyethylene terephthalate (PET), acrylonitrile-butadiene-styrene (ABS) plastic, and the like. Depending on the nature of the forward portion 36, it may be adhesively bonded, mounted with fasteners, fused, or otherwise secured to the flange portion 34. In some embodiments, the attachment between the flange portion 34 and the forward portion 36 may not be permanent. For example, the flange portion 34 may be magnetic, and the forward portion 36 may be magnetically attached to it. Alternatively, the flange portion 34 may include fixed loops of elastic or a reusable adhesive surface or coating that can serve to temporarily grab and hold objects. Slots, tracks, holes, or grooves may be provided in the flange portion 34 for connecting with and securing forward portions 36 or external objects. Thus, although certain portions of the description below may assume that the forward portion 36 is permanently attached to the flange portion 34, that need not be the case in all embodiments.

As will be described below in more detail, the flange portion 34 need not be a continuous sheet in all embodiments, and it need not extend from all of the edges or the entire perimeter of the forward portion 36. Depending on the nature of the object 14, the flange portion 34 may or may not be visible when the object 14 is in the object receptacle 12. Particularly if the flange portion 34 is to be visible, it may have aesthetic and/or useful features of its own, as will be described below in more detail.

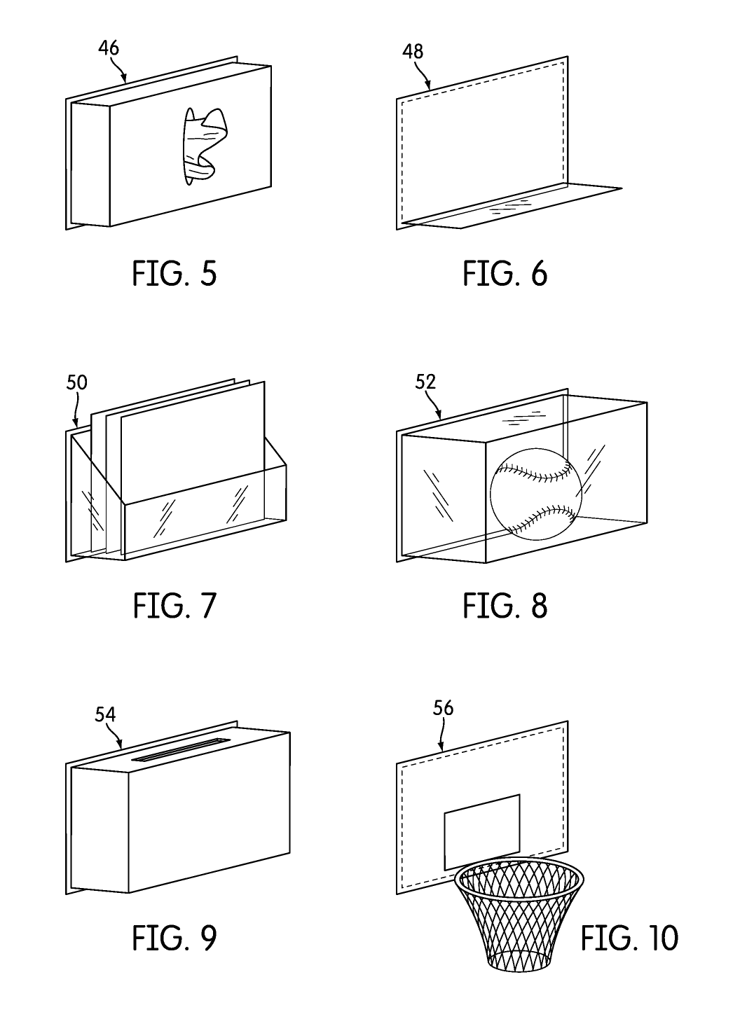

Thus, the system 10 of FIGS. 1-3 provides a convenient “snap in, snap out” system for interchangeably mounting objects 14 to a wall. FIG. 4 is an exploded view of the system 10, illustrating the open position of the object receptacle 12. As shown in FIG. 4, any object 14 that includes a compatible flange portion 34 may be mounted within the object receptacle 12. In this context, “compatibility” refers to a flange portion 34 that can be engaged by or held within or by the object receptacle 12. The dimensions and nature of the forward portion 36 of the object 12 may vary considerably, and a wide range of examples will be described below.

In addition to holding and retaining the object 14, the object receptacle 12 typically also provides a means for a user to attach it to a wall. This mounting means may be provided anywhere on the object receptacle, including along the backing members 18 or in the backing sheet 32. Suitable mounting means include, but are not limited to, holes for fasteners to be inserted and grooves or notches that accommodate mounting hardware. Depending on the total weight involved, the object receptacle 12 may be secured to a wall 16 using pressure sensitive adhesive strips. Mounting means may also include loops or locations where loops can be inserted or secured so that wire can be strung between the loops to hang the object receptacle 12. Ultimately, the object receptacle 12 need not provide specific mounting structures as long as it is compatible, in terms of size and material, with some mounting method. Object receptacles 12 that do not provide specific structure for mounting may, for example, be mounted with adhesives.

Although any method of securement to a wall 16 may be used, FIG. 4 illustrates certain advantages to the use of a backing sheet 32. The backing sheet 32 has a number of predefined openings 38, 40 of different types in predetermined positions. These predefined openings 38, 40 allow the object receptacle 12 to be hung.

There are several particular advantages to the type and placement of the openings 38, 40 that are illustrated in FIG. 4. First, openings 38, 40 are provided at and around the geometric center of the backing sheet 32, which allow the object receptacle 12 to be hung about its geometric center. More specifically, a round opening 38 at the geometric center of the backing sheet 32 allows the object receptacle to be hung about its geometric center by passing a conventional fastener, such as a screw or nail, through it. Using that center opening 38, the object receptacle 12 may be hung in either portrait or landscape orientation. A second set of square-notched openings 40 are near the geometric center, and are sized, shaped, and oriented to accommodate adhesive hangar hardware. One opening 40 is oriented to allow the object receptacle 12 to hang in portrait orientation; the other allows the object to hang in landscape orientation. However, whether the object receptacle is hung in portrait or landscape orientation, because it is hung about its geometric center, the center remains in the same location.

In addition to the openings 38, 40 about the geometric center, the backing sheet 32 includes a number of other openings 38, 40 arrayed at a distance from the center of the object receptacle 12. In some cases, it may be sufficient to mount the object receptacle 12 on the wall 16 using a single fastener secured at the geometric center. However, there will also be cases where one fastener may not be sufficient or when another fastener is desirable, e.g., in order to eliminate the possibility of rotation or displacement on the wall 16 or in order to support a heavier load. The additional openings 38, 40 provide the user with the ability to select how many fasteners will be used and what positions those fasteners will be in. The user may take into account such factors as the overall amount of weight that is likely to be supported by the object receptacle and the center of gravity of the load. If the load is intended to be cantilevered, i.e., the center of gravity is well forward of the object receptacle 12, then it may be helpful to use more than one fastener.

Additionally, as shown in FIG. 4, the backing sheet 32 may be transparent in at least some embodiments, and may have an inscribed or printed grid 42, registration marks, or other alignment indicia in order to allow it to be easily aligned with the wall or with indicia on a placement template, such as the templates disclosed in U.S. Pat. No. 6,880,259.

FIG. 4 also illustrates the interchangeability of system 10. In the view of FIG. 4, two objects 14, 44, each with its own flange portion 34, may be inserted into the object receptacle 20. System 10 is thus, in essence, a modular system; a wide variety of objects and devices may be used in system 10, provided that each object has some sort of flange portion that allows it to be mounted in an object receptacle 12. Generally speaking, objects useable in system 10 may include writing and working surfaces (e.g., cork boards, chalk boards, and dry-erase white boards), containers and other storage devices, tools and tool holders, and amusement devices. The object receptacle 12 may have a defined thickness of material that it is designed to accommodate; significantly thicker or thinner materials may cause the clamping members 20 not to meet or mesh properly at the mitered corners. Thus, in embodiments of system 10, it is advantageous if the combined thickness of the backing sheet 32 and any flange portion or portions 34 is within the range of thicknesses that can be accommodated by the object receptacle 12. In this particular context, the term “accommodated” refers to the range of thicknesses that can be accommodated by the object receptacles 12 with the edges of the clamping members 20 meshing properly. With other object receptacles, the term “accommodated” refers to the range of thicknesses that can be accepted by the frame without being too thin or too thick.

As shown in FIG. 4, the flange portion 34 of the object 44 may be either an integrally-formed lip or a continuous sheet that backs the entire object 44. Different types of flange portions will be described in greater detail below.

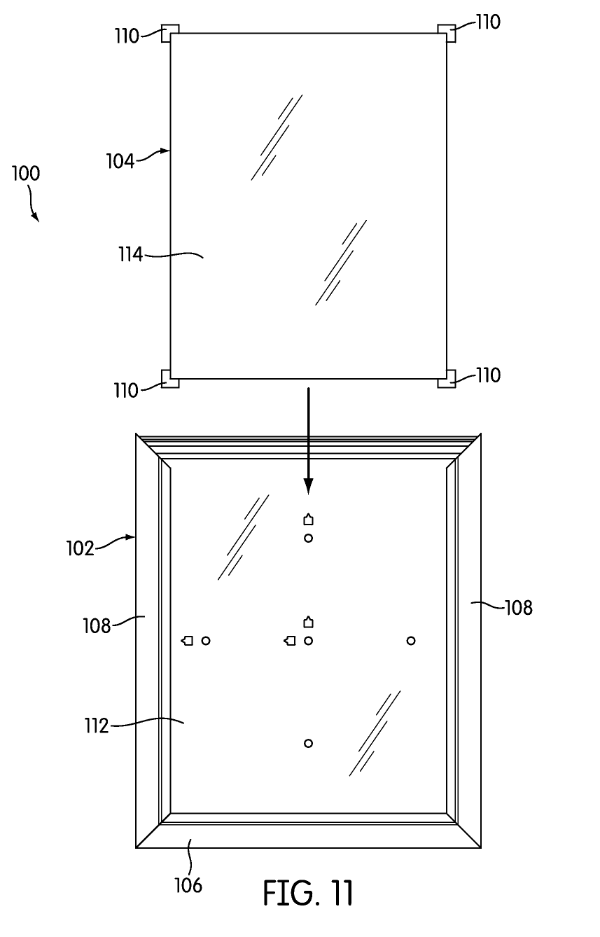

FIGS. 5-10 are perspective views illustrating a few examples of objects that may be used with system 10. FIG. 5 illustrates a facial tissue holder 46. FIG. 6 illustrates a horizontally-extending shelf 48, which may be combined with a vertically-extending dry erase writing surface. FIG. 7 illustrates a file holder and sorter 50. FIG. 8 illustrates a display container 52 that holds a baseball. FIG. 9 illustrates a ballot or suggestion box 54 that is adapted to accept ballots or comment cards, and FIG. 10 illustrates a small basketball hoop 56. Other types of objects that may be used include tool holder boards. As those of skill in the art will realize, a wide variety of objects 14 may be created, in any combination, to address specific needs.

As is evident from FIGS. 5-10, system 10 as a whole is a modular system, in that a number of interchangeable objects may be used in the same receptacle. However, the objects 14, 44, 46, 48, 50, 52, 54, 56 may themselves be considered to be modular because of the potential uniformities created by similar flange portions. In some cases, the objects 14, 44, 46, 48, 50, 52, 54, 56 may be mounted or used alone, without a corresponding receptacle or receptacles.

In FIGS. 1-10, each of the objects 14, 44, 46, 48, 50, 52, 54, 56 has a flange portion that extends uniformly on all four sides of the forward portion 36 of the object. However, that need not be the case in all embodiments; rather, a flange portion 34 need be only as large as necessary to be securely installed in the object receptacle 12, and may only extend from a small portion of the total perimeter of the forward portion 36.

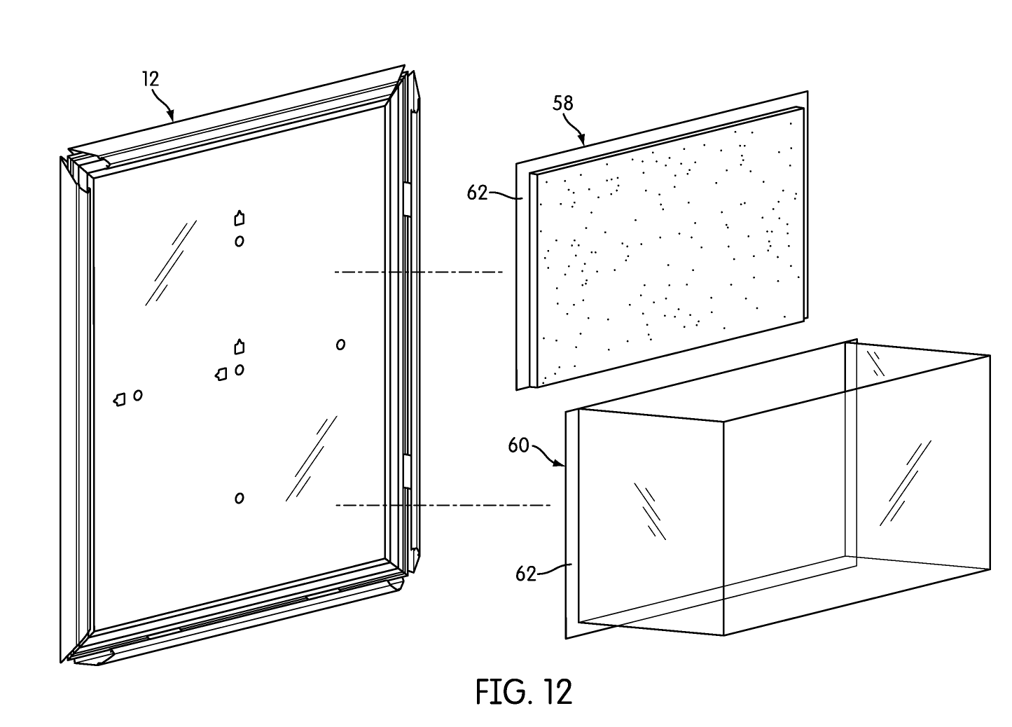

FIG. 11 is an exploded perspective view of an embodiment of a system 100 for interchangeably mounting objects that illustrates that principle and several others. Like system 10, system 100 includes an object receptacle 102 and an object 104. However, unlike in system 100, the object receptacle 102 has only three front or molding members. These three members include a horizontally-extending member 106 at the bottom of the receptacle 102 and two longer, vertically-extending members 108 that are joined to the horizontally-extending member 106 to form a U-shape. Because there is no outermost top member, the object 104, in this case, a dry-erase writing board, may be inserted into the object receptacle 102 from the top, as indicated in FIG. 11, rather than from the front. One advantage of this type of arrangement is that while the object receptacle 102 may have the front-opening structure shown with respect to the object receptacle 12 of system 10, it need not have that structure or functionality; objects could instead be inserted from the top, or from any side, if the member on that side is omitted. Since the object receptacle 102 is top-loading, if a backing is provided, the backing 112 of the object receptacle 102 may be fixed in place or contiguous with or connected to the rest of the receptacle, rather than being a removable sheet or plate. Of course, the object receptacle 102 need not remain three-sided; after the object 104 is inserted, the forth side or member may be installed and/or secured in place.

Another difference illustrated in system 100 of FIG. 11 is that the object 104 does not have a single, continuous flange portion 34. Instead, four individual flange portions 110 are positioned at the corners of the forward portion 114 of the object 104, extending only the minimum necessary to securely engage the object receptacle 102. Such an arrangement requires less material than a continuous flange portion 34. Additionally, in some embodiments, the flange portions 110 may be provided separately and may include adhesive pads or other attachment mechanisms that would allow them to be attached to any object, rendering that object useable with systems 10, 100 according to embodiments of the invention.

In the above description, the objects 14, 44, 46, 48, 50, 52, 54, 56 generally conform to the dimensions of the object receptacles 12, 102. However, that need not be the case. For example, if one of the molding pieces is missing, as is the case with the object receptacle 102, then the object may exceed the dimension(s) of the object receptacle 102 in that direction. Additionally, an object 14, 44, 46, 48, 50, 52, 54, 56 may exceed the dimensions of the object receptacle 12, 102 in any dimensions if it extends forwardly far enough to completely clear the object receptacle 12, 102.

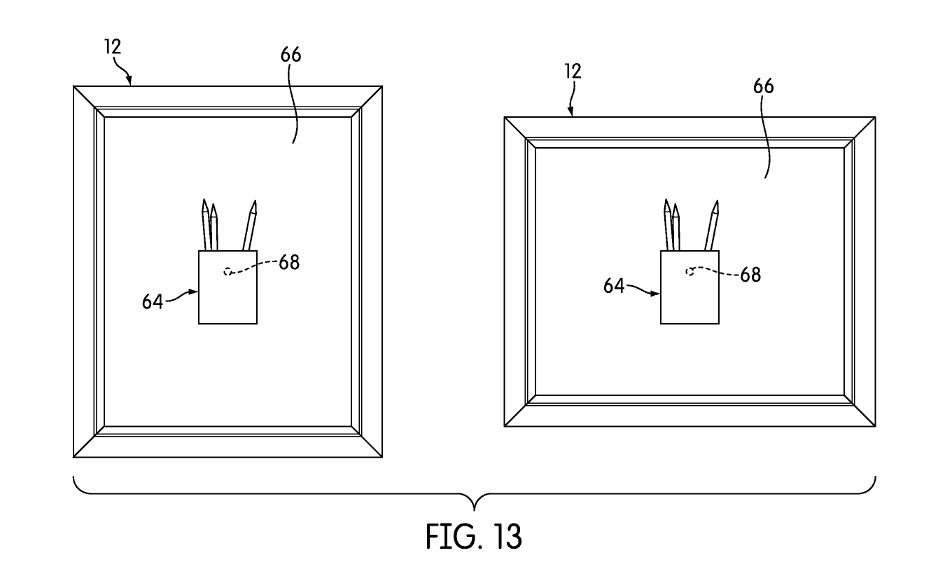

In some embodiments, there may be more than one object in an object receptacle. FIG. 12 is an exploded perspective view illustrating this concept with respect to system 10. In the view of FIG. 12, there are two objects 58, 60, one a cork board and one a file sorting container, being inserted into a single object receptacle 12. Each object 58, 60 is half the height that a comparable object would be, and each object 58, 60 has a flange portion 62 that extends around three sides, with the fourth side, the lowermost edge on the upper object 58 and the uppermost edge on the lower object 60, unflanged to allow the two objects 58, 60 to rest adjacent to one another in the object receptacle 12.

Any number of objects may be placed in a single object receptacle 12. If more than two objects 58, 60 are placed in a single object receptacle 12, each object may have flange portions on its left and right sides, but no flange portions on the top and bottom, although the top-most and bottom-most objects may have flange portions on their tops and bottoms, respectively. However, if gaps between the two or more objects are permissible, then the objects may have flange portions on all four sides.

A variation on the arrangement shown in FIG. 12 is also possible. In some embodiments, a larger mounted structure may include many receptacle locations where individual objects may be secured, similar to a cluster frame.

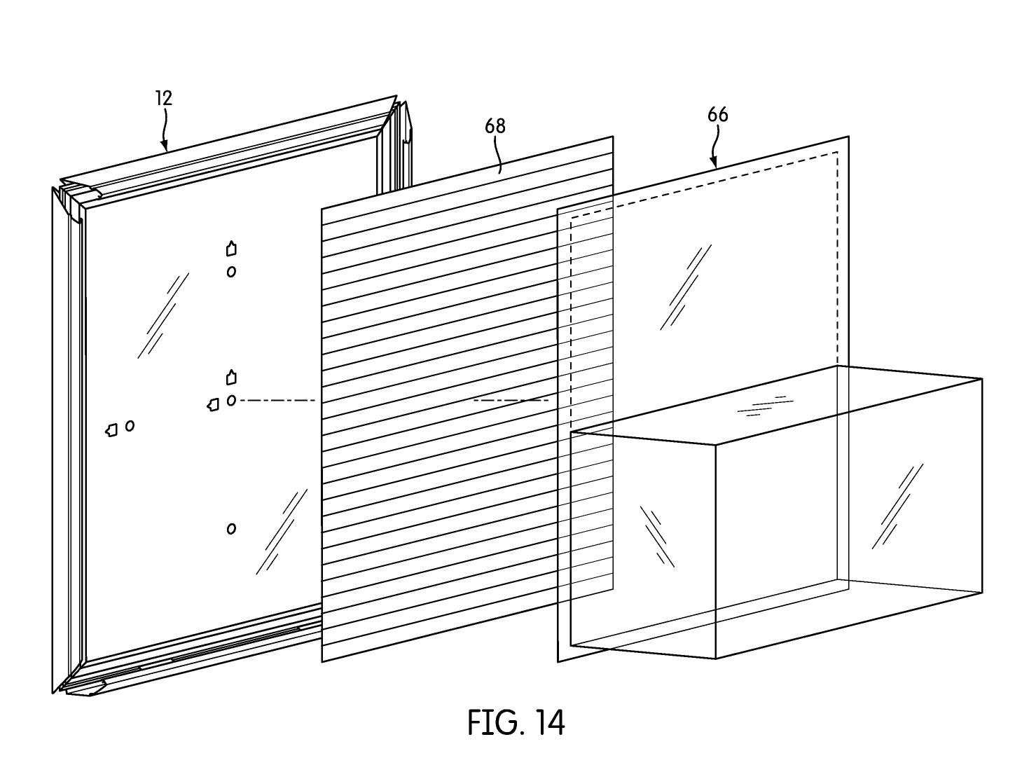

In many embodiments, the flange portion 34 is fixed in position with respect to the forward portion 34 of the object 14. In some embodiments, however, that may not be the case. FIG. 13 illustrates an embodiment in which the object 64, in this case, a pencil holder, is mounted for rotation with respect to its flange portion 66. More specifically, a fastener 68, such as a rod, rivet, or screw, connects the object 64 to the flange portion 66 such that the object 64 can rotate or be moved with respect to the flange portion 66. Other fasteners and means of fastening, such as hook-and-loop strips and magnetic attachment may be used. As shown in FIG. 13, this has a particular advantage: regardless of whether the receptacle is hung in a portrait orientation or a landscape orientation, the object 64 can be moved into the correct position. In addition to rotation, in some cases, objects may be mounted in grooves or slots in the flange portion, allowing the object to move vertically and horizontally with respect to the flange portion. Objects may be detachable from and reattachable to the flange portion 66.

In FIG. 13, since the object 64 is small relative to the size of the flange portion 66 and the object receptacle 12, a significant area of the flange portion 66 is visible. If a flange portion, such as flange portion 66, is exposed, it may also include any number of features, and may serve as a “mountable surface” for other objects, either temporarily or permanently. For example, the flange portion 66 could be made of a magnetic or magnetizable material, such that items can be magnetically attached to it. It could provide openings in which hooks could be secured to mount other items or tools. It may also include printed indicia, informational instructions or branding, or aesthetic features. It should also be noted that the flange portion 66 need not be entirely flat and planar, provided that enough of it is flat to engage the object receptacle 12.

For example, a flange portion may be printed, inscribed, or otherwise provided with indicia that allow it to be used as a game board, such as a checker board, a chess board, or a backgammon board, intended to be used with magnetic game pieces that will stick to it. Alternatively, other releasable means of fastening, such as hook-and-loop fastener strips, clips, and releasable adhesives may be used.

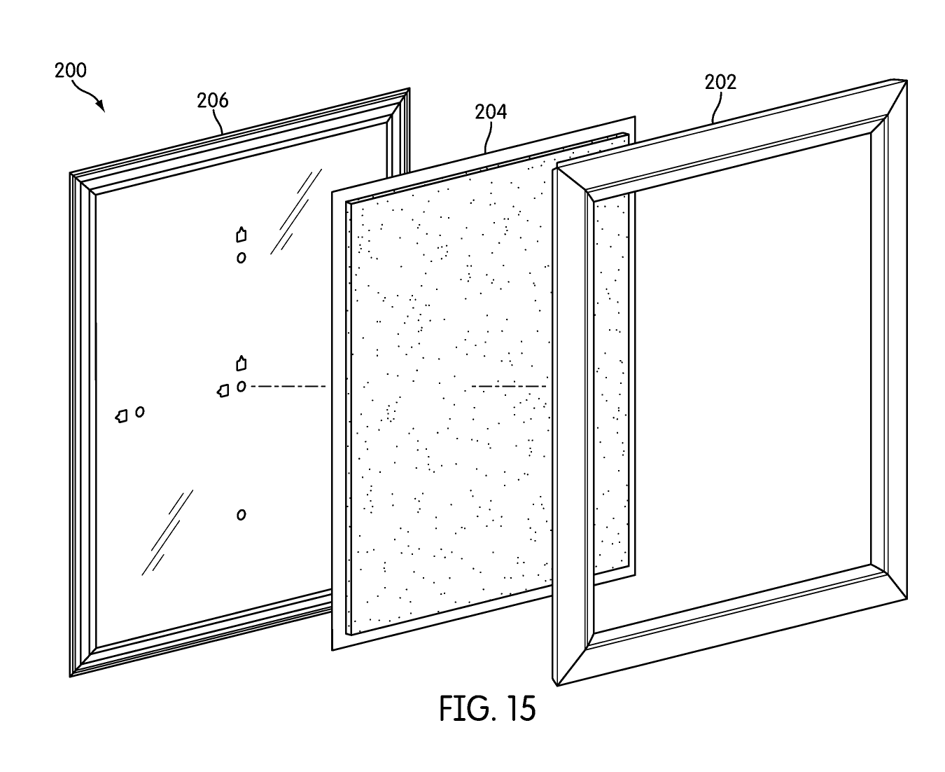

Certain aesthetic and informational features may also be present or added to embodiments of the invention. For example, FIG. 14 is an exploded perspective view of an object receptacle 12 and an object 66 according to an embodiment of the invention. In the illustrated embodiment, the object 66 is made of a transparent or translucent material, such as glass or PMMA. A decorative or informational sheet 68 is inserted between the object receptacle 12 and the object 66 such that the color, pattern, or information on the sheet 68 is visible through the object 68. The decorative or informational sheet 68 may serve a purely aesthetic function, or it may serve a functional purpose, providing instructions, information, or branding that can be read through the object 66. The sheet 68 may have any thickness, provided that the total thickness of the sheet 68, the flange portion 66, and any backing sheet 34 is within the range of thicknesses that can be accommodated by the object receptacle 12. In some embodiments, the object 66 may be partially transparent, etched, or colored itself, so that it interacts with the color, design, or printed indicia on the decorative or informational sheet 68 to produce a particular effect.

In some situations, providing a transparent or translucent backing to the object receptacle—or simply omitting a backing—and providing a transparent or translucent object may itself create an aesthetic effect, in the same way that a so-called “floating frame” would.

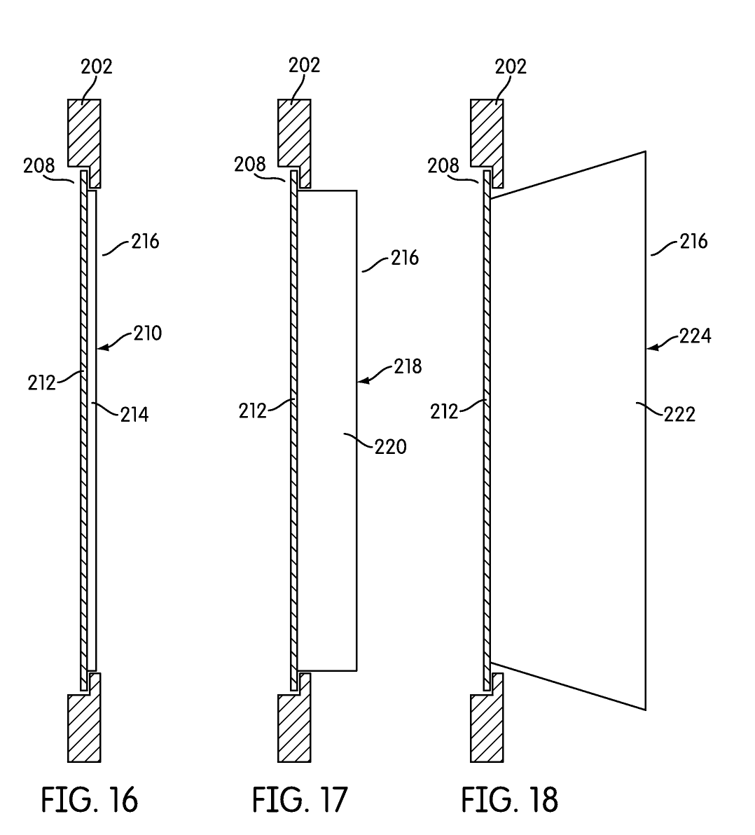

As was explained above, in embodiments of the invention, the object receptacles 12, 102 may be front loading, top loading, or side loading. In addition, object receptacles may also be rear-loading. FIG. 15 is an exploded perspective view of a system 200 according to another embodiment of the invention in which the object receptacle is rear-loading. In system 200, the object receptacle comprises a molding 202, which may be made of wood, metal, plastic, or any other material typically used for a frame. An object 204 is inserted into the molding 202 from the rear, and a backing sheet 206 is placed behind the object 204, such that the object 204 is sandwiched between the molding 202 and the backing sheet 206. As in other embodiments, the object 206 is exposed through the central opening of the molding 202, and extends in or beyond the plane in which the molding 202 extends.

In essence, an arrangement like that of system 200 could allow any conventional rear-loading frame to be used as an object receptacle. If a conventional front-loading frame were to be used, any glass or PMMA front sheet in the frame would typically be removed in order to allow space for the object 204, so that the object 204 is exposed.

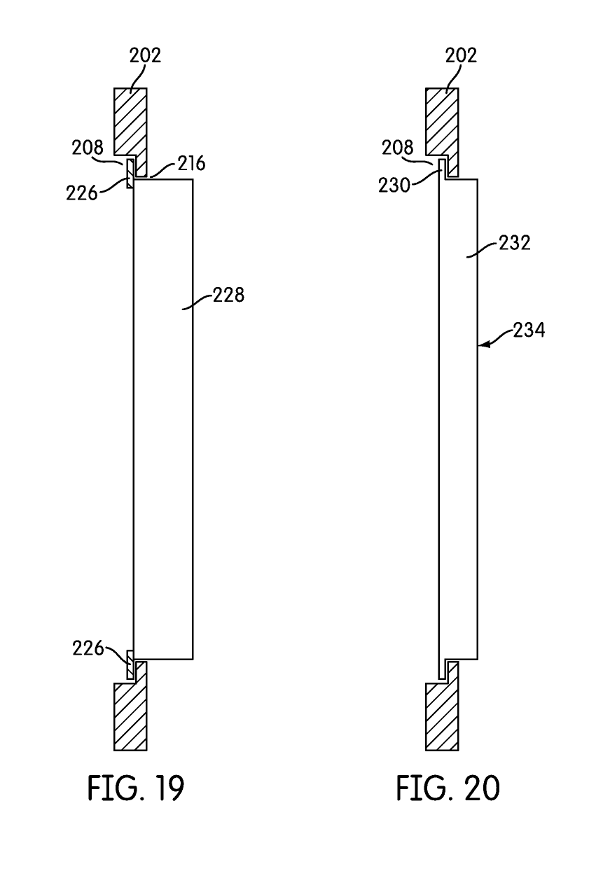

There are several different potential arrangements and methods of securing objects within a frame or other receptacle. Some of these arrangements were described above with respect to the other systems 10, 100. FIGS. 16-20 are schematic sectional views illustrating various arrangements for the useable and flange portions of the object, as well as how those objects fit into a molding.

FIG. 16 illustrates a situation generally analogous to that illustrated in FIGS. 1-3. The molding 202 defines a recessed portion or groove 208 in which an object 210 can sit. In FIG. 16, the object 210 includes a flange portion 212 and a forward portion 214 that extends forwardly of the flange portion 212. The flange portion 212 is a continuous sheet that extends horizontally and vertically outward from all sides of the forward portion 214. The forward portion 214 itself is exposed through the central opening 216 defined by the molding 202 and extends into the plane of the molding 202, but is thin enough that it does not extend beyond the outermost plane of the molding 202.

In the view of FIG. 17, the object 218 once again has a flange portion 212 that is similar to the flange portion 212 of FIG. 16—it extends horizontally and vertically outward from all sides of the forward portion 220. However, the forward portion 220 of the object 218 has considerably more forward extent than the forward portion 214 of the object 210; the forward portion 220 extends forwardly out of the molding 202. However, the horizontal and vertical dimensions of the forward portion 220 essentially conform to the size and shape of the central opening 216 in the molding.

As was described above, the forward portions of objects need not be limited to the size of the central opening. Rather, as shown in FIG. 18, the forward portion 222 of an object 224 may have any height and width and any depth so long as it is shaped in such a way that it clears the central opening 216 and molding 202. The forward portion 222 of the object 224 is generally trapezoidal for purposes of illustration; however, forward portions 222 may have regular or irregular shapes. As those of skill in the art will note, the shape of object 224 makes it more suitable for use with front-loading receptacles, such as the object receptacle 12 of FIGS. 1-4. However, an object such as object 224 may be used with a rear- or side-loading frame if the object is attached to the flange portion 212 from the front after the flange portion 212 is seated in the receptacle.

In FIG. 19, the flange portions 226 are different. Specifically, instead of being comprised of a continuous sheet, two smaller, individual flange portions 226 are attached to respective top and bottom edges of the forward portion 228. The forward portion 228 is similar to the forward portion 220 of FIG. 17.

In FIG. 20, the flange portion 230 is integral with the forward portion 232, as would be the case, for example, if the object 234 is a single-piece molded component. Many plastic containers, such as file holding and sorting containers, and translucent display containers may be made in this way. Objects with integral flanges may also be machined or manufactured in any other way. As FIGS. 16-20 illustrate, any object that can fit through a frame may be used, and objects that cannot fit through the frame may be attached to a flange portion after the flange portion is positioned.

Although the term “molding” is used above, and traditional picture frames may certainly be used in systems according to embodiments of the invention, as those of skill in the art will realize, any front-retaining member or inwardly-extending flange capable of securing the object may be used. These front-retaining members may or may not have the decorative or aesthetic aspects of a traditional frame molding.

Systems 10, 100, 200 according to embodiments of the invention may include only a single object receptacle 12, 102 hung alone on a surface, or they may include multiple object receptacles 12, 102 hung in proximity to one another. Thus, a system 10, 100, 200 may be used to hang a single cork board, white board, or file holder, or it may be used to hang a group of such elements together on a wall. If multiple object receptacles 12, 102 are to be hung on a wall together, they may be hung individually by a conventional process of locating, sizing, and fastening them to the wall.

However, as was noted earlier, templates may be used to facilitate the process of hanging object receptacles 12, 102 and may form an integral part of systems 10, 100, 200 according to embodiments of the invention. As one example, the templates disclosed in U.S. Pat. No. 6,880,259 may be used in embodiments of the invention.

While the invention has been described with respect to certain embodiments, the embodiments are intended to be exemplary, rather than limiting. Modifications and changes may be made within the scope of the invention, which is defined by the appended claims.

What is claimed is:

1. An object, comprising:
a forward portion connected to a flange portion, the forward portion extending forwardly of the flange portion, the flange portion extending horizontally and vertically outward from at least one of the edges of the forward portion and having a defined thickness;
wherein the object is sized and adapted to fit within a frame, the defined thickness of the flange portion being within a defined range of thicknesses of material that can be accommodated by the frame.

2. The object of claim 1, wherein the flange portion is a contiguous sheet to which the forward portion is attached.

3. The object of claim 1, wherein the flange portion is a horizontally- and vertically-extending lip integral with the forward portion.

4. The object of claim 1, wherein the flange portion comprises a set of horizontally- and vertically-extending tabs that are secured to a rear surface of the forward portion such that they extend horizontally and vertically outward from the edges thereof.

5. The object of claim 1, wherein the forward portion is a writing surface, a posting board, a container, a shelf, a hanger board for displaying or organizing two-dimensional or three-dimensional objects, or an amusement device.

6. The object of claim 5, wherein the forward portion is a writing surface and the writing surface is a dry-erase board or a chalk board.

7. The object of claim 5, wherein the forward portion is a posting board and the posting board is a cork board or a magnetic board.

8. The object of claim 5, wherein the forward portion is a container and the container is a file holder or a display container.

9. The object of claim 5, wherein the forward portion is an amusement device and the amusement device is a basketball hoop.

10. An interchangeable object mounting system, comprising:
a molding including peripheral structure and a central opening; and
an object including a forward portion connected to a flange portion, the forward portion extending forwardly of the flange portion, the flange portion extending horizontally and vertically outward from at least one of the edges of the forward portion and having a defined thickness, the flange portion being adapted to fit within the molding such that the forward portion is exposed through the central opening of the molding;
wherein the flange portion retains the object within the molding.

11. The interchangeable object mounting system of claim 10, wherein the flange portion bears against a rear surface of the peripheral structure of the molding.

12. The interchangeable object mounting system of claim 10, further comprising securing structure adapted to secure the object within the molding.

13. The interchangeable object mounting system of claim 12, wherein the securing structure comprises a backing.

14. The interchangeable object mounting system of claim 12, wherein the securing structure comprises a wall on which the molding is mounted.

15. The interchangeable object mounting system of claim 10, wherein the forward portion is a writing surface, a posting board, a container, a shelf, a hanger board, or an amusement device.

16. The interchangeable object mounting system of claim 10, wherein the forward portion of the object extends into the plane of or forwardly of the molding.

17. The interchangeable object mounting system of claim 16, wherein the forward portion extends beyond the molding in at least one of height or width and in depth.

18. The interchangeable object mounting system of claim 10, wherein the flange portion comprises a continuous sheet attached to the forward portion that extends outwardly on at least two sides of the forward portion.

19. The interchangeable object mounting system of claim 18, wherein the flange portion extends outwardly on all sides of the forward portion.

20. The interchangeable object mounting system of claim 10, wherein the flange portion comprises a set of at least two members that attach to respective edges of the forward portion on a rear side thereof.

21. The interchangeable object mounting system of claim 10, wherein two or more objects are positioned adjacent to one another in the molding.

22. The interchangeable object mounting system of claim 10, wherein the forward portion is removable from the flange portion.

23. An interchangeable object mounting system, comprising:
an object receptacle adapted to be mounted to an essentially vertical surface, including
at least three elongate peripheral backing members connected to each other at ends thereof to form a U-shape,
a corresponding plurality of at least three peripheral clamping members, each of the peripheral clamping members being hingedly connected to one of the peripheral backing members for hinged movement between an open position that allows objects to be placed between the peripheral backing members and the peripheral clamping members and a closed position that retains objects placed between the peripheral backing members and the peripheral clamping members, the peripheral backing members and the peripheral mounting members accommodating a defined range of thicknesses of material therebetween and defining a central opening, and
resilient members bearing between the peripheral backing members and the peripheral clamping members that bias the peripheral clamping members toward the closed position;
at least one object including
a flange portion sized and arranged to be inserted between the peripheral backing members and the peripheral clamping members, the flange portion having a thickness within the defined range of thicknesses and extending along at least two sides of the object, and
a forward portion connected to or integral with the flange portion, the forward portion extending forwardly of the flange portion and being exposed through the central opening of the object receptacle when the object is in position between the peripheral backing members and the peripheral clamping members.

24. The interchangeable object mounting system of claim 23, wherein the object receptacle further comprises a fourth peripheral backing member and a corresponding fourth peripheral clamping member connected thereto, such that the peripheral backing members and the peripheral clamping members form a four-sided frame.

25. The interchangeable object mounting system of claim 23, wherein the flange portion of the at least one object extends on at least two sides of the object.

26. The interchangeable object mounting system of claim 23, wherein the at least one object comprises at least two objects mounted adjacent one another in the object receptacle.

27. The interchangeable object mounting system of claim 23, wherein the forward portion of the at least one object is a writing surface, a posting board, a container, a shelf, a hanger board, or an amusement device.

28. The interchangeable object mounting system of claim 23, further comprising a backing sheet adapted to be inserted between the peripheral backing members and the peripheral clamping members, the backing sheet including openings in predefined locations allowing the object receptacle to be hung about its geometric center by attaching mounting hardware to the backing sheet.

29. The interchangeable object mounting system of claim 28, wherein a thickness of the backing sheet and a thickness of the flange portion together are within the defined range of thicknesses.
